(19) United States
(12) Patent Application Publication
(10) Pub. No.: US 2013/0080285 A1
(43) Pub. Date: Mar. 28, 2013

(54) REUSING THIN PLASTIC PELLETS MADE FROM RECYCLED PLASTIC WASTE AS DESIGN ELEMENT AND FILLER

(71) Applicants: Amy Mosier, Austin, TX (US); Adam Mosier, Austin, TX (US)

(72) Inventors: Amy Mosier, Austin, TX (US); Adam Mosier, Austin, TX (US)

(21) Appl. No.: 13/242,096

(22) Filed: Sep. 23, 2011

(51) Int. Cl. G06Q 30/06; B65D 90/02

(52) U.S. Cl. 705/26.5; 220/660

(57) ABSTRACT

Methods and apparatuses for designing a decorative arrangement using thin plastic pellets made from recycled plastic waste are provided. Embodiments of the present invention reuse plastic pellets as a filler for articles of manufacture or as a decorative filler.

### FIELD

The present invention relates to reusing thin plastic pellets made from recycled plastic as a design element and filler.

### BACKGROUND

National and local governments, companies, institutions such as schools, and individuals have instituted environmental initiatives to prevent pollution and conserve resources and energy by managing materials and waste more efficiently. Strategies for effectively managing materials and waste include reducing, reusing, and recycling materials discarded by industry and the general public. For example, the U.S. Environmental Protection Agency (EPA) has instituted a national program to increase recycling and reuse of industrial byproducts generated during manufacturing and industrial processes (“industrial material recycling”).

Nearly every industrial process produces different types of usable materials (“byproducts”). These byproducts may be recycled or reused in a variety of diverse applications. For example, byproducts may be used as substitutions for raw materials in the manufacture of other products. Recycling and/or reusing byproducts can save resources and energy and reduce greenhouse gas emissions.

### BRIEF DESCRIPTION OF THE DRAWINGS

FIG. 1 illustrates an exemplary use of plastic pellets made from recycled plastic waste as a decorative filler for a vase.

FIG. 2 illustrates another exemplary use of plastic pellets made from recycled plastic waste as a decorative filler.

FIG. 3 illustrates an example process for designing a decorative arrangement using plastic pellets made from recycled plastic waste as a decorative filler.

FIG. 4 illustrates an example computer operable designing a decorative arrangement using plastic pellets made from recycled plastic waste as a decorative filler.

### DETAILED DESCRIPTION

Embodiments of the present invention reuse plastic pellets as a filler for articles of manufacture or as a decorative filler.

Recyclable plastic waste (e.g., low density polyethylene plastic waste) has been used to manufacture plastic pellets that can be used as a starter material for new material. More specifically, recyclable plastic waste can be ground up into small pieces and fed into a plastic extrusion machine, which melts and filters the plastic. The processed plastic then can be passed through a die to form plastic pellets. For example, the plastic pellets can each be 2 mm round by 3 mm thick and weigh approximately 0.03 grams, for example; however, the plastic pellets can be any dimension and weight. The plastic pellets can be formed having a certain color based on the color(s) of the recyclable plastic waste used to make the pellets. The plastic pellets then can be used as a raw material feed stock to manufacture new material.

The plastic pellets are lightweight and easy to handle. They can be colorful and the color should not fade. They have no scent/odor. They have a long shelf life (e.g., they may not decompose). They can float in water and can be easily cleaned. Furthermore, the plastic pellets can save resources and energy because they are made from recycled material and are themselves recyclable.

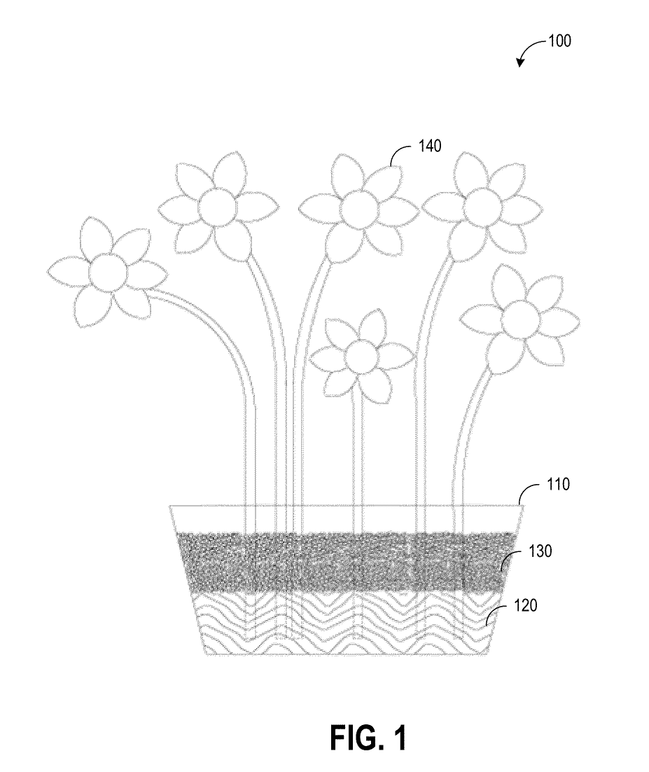

These qualities can make the plastic pellets use as a decorative filler desirable. FIG. 1 illustrates an exemplary use of the plastic pellets as a decorative filler for a vase. As shown in FIG. 1 when a vase 110 is filled with water 120, pellets 130, and other decoration pieces such as flowers 140, a decorative arrangement 100 can be achieved. As shown in FIG. 1, the plastic pellets 130 can float in the water 120.

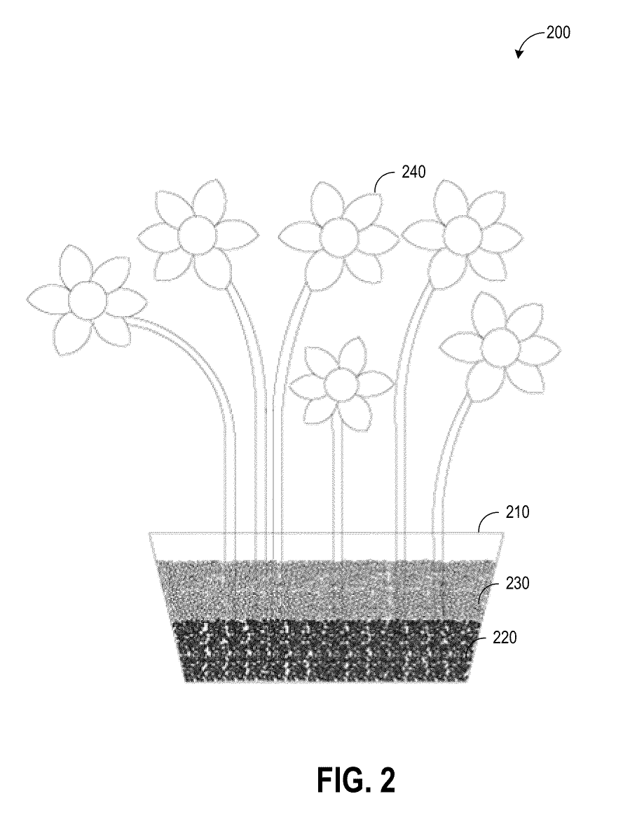

FIG. 2 illustrates another exemplary use of the plastic pellets as a decorative filler. As shown in FIG. 2, a glass container 210 is filled with pellets having a first color 220 and pellets having a second color 230. The arrangement 200 can include other decorative pieces such as flowers 240.

The plastic pellets may be desirable over other traditional arrangement fillers such as glass beads, rocks, sand, and gel beads, for example.

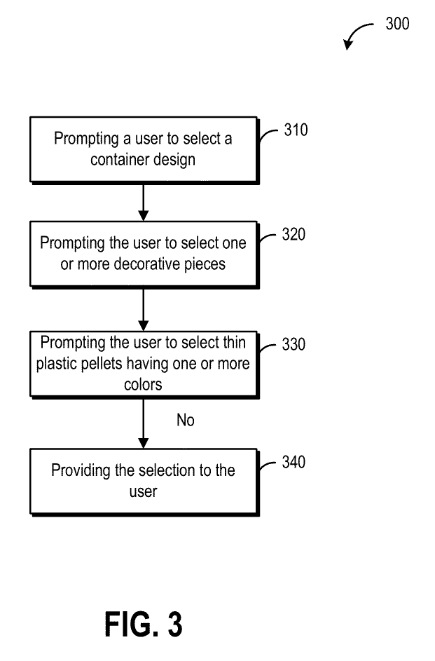

Numerous arrangements can be achieved using the plastic pellets. FIG. 3 illustrates an example process 300 for designing a decorative arrangement including a vase, one or more decorative pieces, and pellets.

At stage 310, a user is prompted to select a container design (e.g., vase 110 or glass container 210) among multiple container designs. This disclosure is not limited to any particular container design. This disclosure can apply to any container design. Once a container design is selected, the process 300 proceeds to stage 320.

At stage 320, a user is prompted to select one or more decorative pieces (e.g., flower 140 or sea shells, branches, etc.) to include in the container selected at stage 310. This disclosure is not limited to any particular decorative pieces. This disclosure can apply to any decorative pieces. Once the decorative pieces are selected, the process 300 proceeds to stage 320.

At stage 330, a user is prompted to select plastic pellets having one or more colors to include in the container selected at stage 310.

At stage 340, the container, decorative pieces, and plastic pellets selected at stages 310 through 340, respectively, are provided to the user. For example, the selections may be shipped to the user. Thereafter, the user can create an arrangement created using the selections.

The plastic pellets can be used for numerous other uses. For example, the pellets can be used for arts and crafts. Utilizing a clear bottle, pellets of varying color can be arranged to make artistic designs similar to sand art projects. Utilizing craft paper or an art board, pellets can be glued onto the surface to create mosaic designs and collages. The plastic pellets can also be used in combination with grout as a filler in between tiles and stones, for example, on a table base. The pellets also can be used as filler for bean bags, pillows, floats, etc. As yet another example, the plastic pellets can be used for therapeutic purposes. For example, fabric pouches can be filled with pellets and sewn shut to prevent leakage. The pellet bags are then used similar to stress relief balls in that they provide therapeutic stress relief and strengthen hands when handled and squeezed. When filled in a hollow container (e.g., with less than 25% volume), the pellets act as a noise maker. Hollow pictures frames made of clear plastic can be filled with pellets to provide a colorful background or border. Bean bags can be filled with pellets to provide a different weighted product than typical bean bags. Pool floats can be filled with pellets to provide a colorful alternative to clear floats.

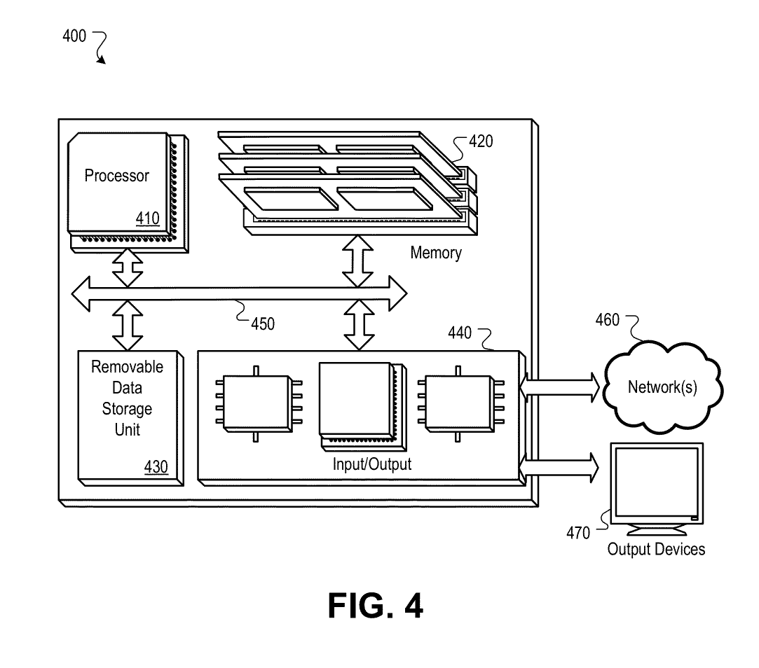

FIG. 4 illustrates an example computer 400 operable to perform stages 310 through 340 of the example processes 300 of FIG. 3. The computer 400 can include a processor 410, a memory 420, a removable data storage unit 430, and an input/output device 440. Each of the components 410, 420, 430, and 440 can, for example, be interconnected using a system bus 450. In some implementations, the computer 400 can include one of more interconnected boards where each board comprises components 410, 420, 430, and 440. The processor 410 is capable of processing instructions for execution within the computer 400. For example, the processor 410 can be capable of processing instructions for executing stages 310 through 340 of the example processes 300 of FIG. 3 in the computer 400. In some implementations, the processor 410 is a single-threaded processor. In other implementations, the processor 410 is a multi-threaded processor. The processor 410 is capable of processing instructions stored in the memory 420 or on the storage device 430.

The memory 420 stores information within the computer 400. In some implementations, the memory 420 is a computer-readable medium. In other implementations, the memory 420 is a volatile memory unit. In still other implementations, the memory 420 is a non-volatile memory unit.

In some implementations, the storage device 430 is capable of providing mass storage for the computer 400. In one implementation, the storage device 430 is a computer-readable medium. In various different implementations, the storage device 430 can, for example, include a hard disk device, an optical disk device, flash memory or some other large capacity storage device. In some implementations, the storage device 430 is not removable.

The input/output device 440 provides input/output operations for the computer 400. In one implementation, the input/output device 440 can include one or more of a wireless interface, WAN/LAN network interface, such as, for example, an IP network interface device, e.g., an Ethernet card, a cellular network interface, a serial communication device, e.g., and RS-232 port, and/or a wireless interface device, e.g., an 802.11 card. In another implementation, the input/output device 440 can include driver devices configured to receive input data and send output data to other input/output devices, as well as sending communications to, and receiving communications from various networks.

Implementations of the device of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

The processes and logic flows described in this specification can be performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, implementations of the subject matter described in this specification can be operable to interface with a set-top-box (STB); an advanced television; or some other computing device that is integrated with or connected to (directly or indirectly) a display, e.g., a CRT (cathode ray tube) or LCD (liquid crystal display) monitor, for displaying information to the user. To provide for input by a user to the computer, implementations of the subject matter described in this specification further can be operable to interface with a keyboard, a pointing device (e.g., a mouse or a trackball), and/or a remote control device.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Particular implementations of the subject matter described in this specification have been described. Other implementations are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

What is claimed:

1. A computer-implemented method of designing a decorative arrangement using thin plastic pellets made from recycled plastic waste, the method comprising:
prompting a user to select a container design;
prompting the user to select one or more decorative pieces to include in the selected container; and
prompting the user to select thin plastic pellets made from recycled plastic waste having one or more colors to include in the selected container.

2. The computer-implemented method of claim 1 further comprising providing the selected container, one or more decorative pieces, and pellets to the user.

3. A decorative arrangement comprising:
a container; and
thin plastic pellets made from recycled plastic waste having one or more colors.

4. The decorative arrangement of claim 3 further comprising one or more decorative pieces.

5. The decorative arrangement of claim 3 further comprising water.

6. A computer readable medium having instructions for causing a computer to execute a method for designing a decorative arrangement using thin plastic pellets made from recycled plastic waste, the method comprising:
prompting a user to select a container design;
prompting the user to select one or more decorative pieces to include in the selected container; and
prompting the user to select thin plastic pellets made from recycled plastic waste having one or more colors to include in the selected container.

7. An article comprising thin plastic pellets made from recycled plastic waste wherein the pellets are used as a filler.

8. The article of claim 7 wherein the article is a bean bag.

9. The article of claim 7 wherein the article is a floatation device.
